(19) United States
(12) Patent Application Publication
(10) Pub. No.: US 2010/0324178 A1
(43) Pub. Date: Dec. 23, 2010

(54) FINELY DIVIDED, STARCH-CONTAINING POLYMER DISPERSIONS

(75) Inventors: Andreas Brockmeyer, Bickenbach (DE); Titus Leman, Shanghai (CN); Roland Ettl, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/518,002

(22) PCT Filed: Dec. 11, 2007
(86) PCT No.: PCT/EP2007/063680

§ 371 Date: Jun. 5, 2009

(30) Foreign Application Priority Data
Dec. 14, 2006 (EP) 06126098.0

(51) Int. Cl. C08L 3/02; C01B 25/18

(52) U.S. Cl. 524/53; 423/304

(57) ABSTRACT

Finely divided starch-containing polymer dispersions which are obtainable by free radical emulsion copolymerization of ethylenically unsaturated monomers in the presence of a redox initiator and an enzymatically degraded starch, the enzymatic starch degradation being stopped by adding an acid comprising at least one phosphorus atom to the reaction mixture, use of an acid comprising at least one phosphorus atom for stopping the enzymatic degradation of starch and use of the finely divided, starch-containing polymer dispersions of emulsion polymers as size for paper and paper products, in particular as surface size.

The invention relates to finely divided starch-containing polymer dispersions which are obtainable by free radical emulsion copolymerization of ethylenically unsaturated monomers in the presence of a redox initiator and an enzymatically degraded starch.

EP-B 257 412 discloses sizes for paper based on finely divided, aqueous dispersions of copolymers which are obtainable by copolymerization of acrylonitrile and/or methacrylonitrile, an acrylate and, if appropriate, other ethylenically unsaturated copolymerizable monomers by an emulsion polymerization method in an aqueous solution of a degraded starch having a viscosity of 0.12 to 0.5 dl/g using hydrogen peroxide or redox initiators. As is evident from the examples, the starch is enzymatically degraded. The enzymatic degradation of the starch is terminated by addition of acetic acid.

Emulsion polymers having a corresponding composition are disclosed in EP-B 276 770. They differ from the sizes disclosed in EP-B 257 412 only in that they are prepared in an aqueous solution of a degraded starch having a viscosity ηᵢ of from 0.04 to less than 0.12 dl/g.

EP-A 307 816 discloses paper sizes which are obtainable by copolymerization of a monomer mixture comprising (i) acrylonitrile, methacrylonitrile and/or styrene, (ii) at least one acrylate or methacrylate, vinyl acetate, vinyl propionate and/or 1,3-butadiene and, if appropriate, (iii) other ethylenically unsaturated copolymerizable monomers by an emulsion polymerization method in an aqueous solution of a degraded cationic starch having a viscosity of from 0.04 to 0.50 dl/g. In particular, hydrogen peroxide and redox initiators are suitable as the polymerization initiator. When an enzymatically degraded starch is used as an emulsifier, the starch degradation is stopped by adding acetic acid before the emulsion polymerization is carried out.

EP-B1 056 783 likewise discloses aqueous, finely divided polymer dispersions which are used for the surface sizing of paper, board and cardboard. The dispersions are obtainable by free radical emulsion polymerization of ethylenically unsaturated monomers in the presence of degraded starch having a number average molecular weight Mₙ of from 500 to 10 000. The monomer mixtures consist of (i) at least one optionally substituted styrene, (ii) at least one C₁-C₄-alkyl(meth)acrylate and (iii) if appropriate, up to 10% by weight of other ethylenically unsaturated monomers. The polymerization is effected in the presence of a graft-linking, water-soluble redox system.

According to the process disclosed in WO 02/14393, sizes and coating materials for paper are prepared by free radical emulsion polymerization of a monomer mixture comprising (i) at least one (meth)acrylate of monohydric, saturated C₃-C₈-alcohols and (ii) one or more further ethylenically unsaturated monomers in the presence of degraded starch and/or of a degraded starch derivative, monomers and initiator being fed continuously to an aqueous starch solution, and the initiator being metered in two portions under specially defined conditions. When an enzymatically degraded starch is used, the starch degradation is stopped by adding acetic acid before the emulsion polymerization is carried out in the aqueous solution of the degraded starch.

WO 00/23479 likewise discloses sizes which are obtainable by free radical emulsion copolymerization of a monomer mixture (A) comprising, for example, (i) at least one optionally substituted styrene, (ii) if appropriate, at least one C₄-C₁₂-alkyl(meth)acrylate and (iii) at least one monomer from the group consisting of methyl acrylate, ethyl acrylate and propyl acrylate in the presence of (B) starch having an average molecular weight of 1000 or greater, the weight ratio of (A):(B) being from 0.6:1 to 1.7:1 and the size being free of emulsifiers or surface-active agents having a molecular weight of less than 1000 and comprising virtually no monomers which have acid groups and are incorporated in the form of polymerized units. Cationic starch, in particular oxidized cationic cornstarch, is preferred as component (B) of the size, and the component (A) preferably consists of a mixture of styrene, n-butyl acrylate and methyl acrylate.

As is evident from the abovementioned prior art, the emulsion polymerization is effected as a rule in the presence of redox catalysts. Owing to the heavy metal content of these initiators, white dispersions are obtained only when a sufficient amount of a complexing agent for heavy metals is added to the dispersions. If size dispersing is carried out using aqueous solutions of enzymatically degraded starch, the starch degradation having been stopped by adding acetic acid, aqueous dispersions are obtained which have an undesired content of volatile organic components, owing to the use of acetic acid.

It is the object of the invention to provide starch-containing polymer dispersions which have as small a proportion as possible of volatile organic components and have virtually no coloration visible to the naked eye.

The object is achieved, according to the invention, by finely divided, starch-containing polymer dispersions which are obtainable by free radical emulsion copolymerization of ethylenically unsaturated monomers in the presence of a redox initiator and an enzymatically degraded starch, if the enzymatically degraded starch used is an aqueous reaction mixture which is obtainable by stopping the enzymatic starch degradation with at least one acid comprising a phosphorus atom.

All acids of phosphorus, e.g. phosphoric acid (H₃PO₄), phosphonic acid (H₃PO₃), phosphinic acid (H₃PO₂), peroxophosphoric acid (H₃PO₅), hypodiphosphonic acid (H₄P₂O₄), diphosphonic acid (H₄P₂O₅), hypodiphosphoric acid (H₄P₂O₆), diphosphoric acid (H₄P₂O₇), peroxodiphosphoric acid (H₄P₂O₈), at least one chain-like polyphosphoric acid of the formula Hₙ₊₂PₙO₃ₙ₊₁, such as triphosphoric acid or tetraphosphoric acid, at least one cyclic metaphosphoric acid of the formula (HPO)₃ₙ, polyhypophosphoric acids of the formula Hₙ₊₂PₙO₂ₙ₊₂, polymetahypophosphonic acids of the formula (HPO₂)ₙ and mixtures of the acids, can be used for stopping the enzymatic degradation of starch.

In addition to said acids of phosphorus, derivatives which are derived, for example, from phosphoric acid or another acid comprising a phosphorus atom by replacing one or two hydroxyl groups by a monovalent radical, such as an alkyl, aryl or amino group, or effecting esterification with a C₁- to C₆-alcohol, such as methanol, ethanol, n-propanol, isopropanol, a butanol, n-hexanol or cyclohexanol, are suitable.

Examples of further derivatives of acids of phosphorus are nitrilotris(methylenetriphosphonic acid), ethylenediaminetetrakis(methylenetetraphosphonic acid), diethylenetriaminepentakis(methylenephosphonic acid), 2-phosphonobutane-1,2,4-tricarboxylic acid, 1-hydroxyethane-1,1-diphosphonic acid, 1-aminoethane-1,1-diphosphonic acid, phosphonoformic acid, phosphonoacetic acid, phenylphosphonic acid and alkylphosphonic acids, such as vinylphosphonic acid, methylphosphonic acid, ethylphosphonic acid, n-propylphosphonic acid, isopropylphosphonic acid, n-butylphosphonic acid, isobutylphosphonic acid, n-hexylphosphonic acid and octylphosphonic acid.

Polymers which comprise at least one vinylphosphonyl unit incorporated in the form of polymerized units, preferably polyvinylphosphonic acid and the copolymers obtainable by free radical copolymerization of vinylphosphonic acid with ethylenically unsaturated monomers, are also suitable for stopping the enzymatic starch degradation. Suitable comonomers are, for example, acrylates and methacrylates of monohydric alcohols having 1 to 8 carbon atoms, acrylic acid, methacrylic acid, styrene and acrylonitrile. The average molar mass M_{w} of the polymers is, for example, not more than 100 000, in general less than 50 000 and preferably in the range of from 500 to 20 000.

The acids which comprise at least one phosphorus atom and are to be used according to the invention may also be used in at least partly neutralized or in at least partly esterified form. A suitable neutralizing agent is, for example, sodium hydroxide solution, potassium hydroxide solution or ammonia. The at least partly neutralized or esterified acids comprising at least one phosphorus atom have, for example, a pKₐ value in the range of from −3 to 9 or have an acid strength such that they reduce the pH of the enzyme-containing solution to a value below 5, preferably below 4, so that the enzymatic degradation is stopped. The suitable compounds must give a pH of less than 5.0 at least in aqueous solution.

Acids which comprise a phosphorus atom are described, for example, in Hollemann-Wiberg, Lehrbuch der Anorganischen Chemie, 91st-100th edition, Verlag Walter de Gruyter, Berlin, New York 1985, pages 646-664, and in Ullmann's Encyclopedia of Industrial Chemistry, Sixth Completely Revised Edition, Wiley-VCH Verlag GmbH Co. KgaA, Weinheim 2003, volume 26, pages 227-229.

Phosphoric acid, phosphonic acid, diphosphoric acid, polyphosphonic acid and/or polyvinylphosphonic acid are preferably used for stopping the starch degradation.

All starch varieties can be enzymatically degraded, for example natural starches or starch derivatives, such as anionically or cationically modified, esterified, etherified or crosslinked starches. The natural starches may be obtained, for example, from potatoes, corn, wheat, rice, peas, tapioca or sorghum. Starches which have an amylopectin content of >80% by weight, preferably >95% by weight, such as waxy cornstarch or waxy potato starch, are also of interest.

In order to characterize a substituted starch in more detail, for example, the proportion of cationic or anionic groups in the respective starch is specified with the aid of the degree of substitution (D.S.). It is in general from 0.005 to 1.0 and preferably in the range of from 0.01 to 0.4.

For stabilizing emulsion polymers, an aqueous starch solution is required. The average molar mass M_{w} of the starch is not more than 100 000. It is in general in the range of from 1000 to 65 000, in particular from 2500 to 35 000. The average molar masses M_{w} of the starch can easily be determined by methods known to the person skilled in the art, for example by means of gel permeation chromatography using a multi-angle light scattering detector.

The enzymatic starch degradation can be carried out separately but is preferably effected in the course of the preparation of aqueous polymer dispersions, by first degrading the starch by known methods in an aqueous medium in the presence of at least one enzyme, for example at a temperature in the range of from 20 to 100° C., preferably from 40 to 80° C. The amount of enzyme is, for example, from 50 mg to 5.0 g/kg of a 5% strength aqueous starch solution, preferably from 200 mg to 2.5 g/kg of a 5% strength aqueous starch solution.

The enzymatic degradation of the starch is continued, for example, until the viscosity of a 2.5% strength by weight aqueous solution of the enzymatically degraded starch is from 10 to 1500 mPa·s, preferably from 100 to 800 mPa·s (Brookfield viscometer, spindle 4, 20 rpm, 20° C.).

The enzymatic degradation of starches is part of the prior art. Enzymes are defined in E.C. classes by the “International Union of Biochemistry and Molecular Biology”, cf. Enzyme Nomenclature 1992 [Academic Press, San Diego, Calif., ISBN 0-12-227164-5 (hardback), 0-12-227165-3 (paperback)] with supplement 1 (1993), supplement 2 (1994), supplement 3 (1995), supplement 4 (1997) and supplement 5 (in Eur. J. Biochem. 1994, 223, 1-5; Eur. J. Biochem. 1995, 232, 1-6; Eur. J. Biochem. 1996, 237, 1-5; Eur. J. Biochem. 1997, 250, 1-6; and Eur. J. Biochem. 1999, 264, 610-650). A constantly updated list of enzyme classes can be found on the internet under http://www.chem.qmul.ac.uk/iubmb/enzyme/.

Preferred enzymes are from the class consisting of the “Hydrolases EC3.-.-.-”, the class consisting of the “Glycosylases EC 3.2.-.-” or the subclass “Glycosidases, which can hydrolyze O- and S-glycosidic compounds EC 3.2.1.-”. For example, α-amylase EC 3.2.1.1., β-amylase EC 3.2.1.2., γ-amylase EC 3.2.1.3 and pullulanase EC 3.2.1.41 are suitable.

If the starch is degraded to the desired molar mass, according to the invention an acid comprising a phosphorus atom is added to the aqueous solution of the degraded starch in order to destroy the enzyme and thus to prevent the further degradation of starch. The amount of acid which has at least one phosphorus atom is, for example, from 0.1 to 20% by weight, preferably from 0.5 to 10% by weight, based on the starch used.

The invention therefore also relates to the use of an acid comprising at least one phosphorus atom for stopping the enzymatic degradation of starch.

An emulsion polymerization is preferably carried out directly in the aqueous solution of the enzymatically degraded starch thus obtainable, by polymerizing ethylenically unsaturated monomers therein in the presence of at least one surface-active compound and at least one free radical polymerization initiator. Emulsion polymers which are obtainable by polymerizing ethylenically unsaturated monomers in the presence of a degraded starch are part of the prior art. They are used, for example, as size for paper, cf. JP-A 58/115 196, EP-B 257 412, EP-B 267 770, EP-A 307 812, EP-A 536 597, EP-A 1 056 783, WO 00/23479, WO 02/14393, EP-B1 165 642 and WO 2004/078807.

Suitable emulsion polymers are, for example, polymers which are composed of at least 40% by weight of so-called main monomers selected from C₁- to C₂₀-alkyl (meth)acrylates, vinyl esters of saturated carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers.

The emulsion polymers preferably are a polymer which comprises at least 70% by weight, particularly preferably at least 95% by weight, of so-called main monomers which are emulsifiable in water.

Examples of main monomers are neutral, monoethylenically unsaturated monomers from the group consisting of the vinylaromatic monomers such as styrene, α-methylstyrene, tert-butylstyrene and vinyltoluene, esters of α,β-monoethylenically unsaturated mono- and dicarboxylic acids having 3 to 8 and in particular 3 or 4 carbon atoms with C₁-C₁₈-alkanols or with C₅-C₈-cycloalkanols, in particular the esters of acrylic acid, of methacrylic acid, or of crotonic acid, the diesters of maleic acid, of fumaric acid and of itaconic acid and particularly preferably the esters of acrylic acid with C₁- to C₁₀-alkanols (═C₁- to C₁₀-alkyl acrylates), such as ethyl acrylate, n-butyl acrylate, isobutyl acrylate, tert-butyl acrylate, n-hexyl acrylate, 2-ethylhexyl acrylate and 3-propylheptyl acrylate and the esters of methacrylic acid with C₁- to C₁₀-alkanols, such as ethyl methacrylate, n-butyl methacrylate, isobutyl methacrylate, tert-butyl methacrylate, n-hexyl methacrylate and the like. Other suitable monomers of this type are vinyl and allyl esters of saturated aliphatic carboxylic acids having 1 to 18 carbon atoms, for example vinyl acetate, vinyl propionate and the vinyl esters of Versatic® acids (vinyl versatates), vinyl halides such as vinyl chloride and vinylidene chloride, and C₂-C₄₀-olefins, such as ethylene, propene, 1-butene, 1-hexene, decene, dodecene and octadecene. Preferred monomers are vinylaromatic monomers, C₂-C₁₈-alkyl acrylates, in particular C₂-C₈-alkyl acrylates, especially tert-butyl acrylate, and C₂-C₁₈-alkyl methacrylates and in particular C₂-C₄-alkyl methacrylates.

In particular, at least 60% by weight of the main monomers which are used in the emulsion polymerization are selected from vinylaromatic monomers, in particular styrene, esters of methacrylic acid with C₂-C₄-alkanols and tert-butyl acrylate. Particularly preferred monomers of this type are vinylaromatic monomers, especially styrene, and mixtures of vinylaromatic monomers with the abovementioned C₂-C₈-alkyl acrylates and/or C₂-C₄-alkyl methacrylates.

The monomer composition may, if appropriate, also comprise up to 20% by weight, based on the total weight of the monomers, of one or more monoethylenically unsaturated monomers (ii), differing from the main monomers (i). The proportion of the monomers (ii) preferably accounts for 15% by weight, in particular up to 5% by weight, of the total amount of the monomers. The monomers (ii) are, however, used only in amounts such that the resulting polymers are insoluble in water so that dispersions are always obtained.

The monomers (ii) include in particular monoethylenically unsaturated monomers which have at least one acid group, such as a sulfo group, a phosphonic acid group or one or two carboxyl groups and the salts of these monomers, in particular the alkali metal salts, e.g. sodium or potassium salts, and the ammonium salts. This group of monomers (ii) includes ethylenically unsaturated sulfonic acids, in particular vinylsulfonic acid, 2-acrylamido-2-methylpropanesulfonic acid, 2-acryloyloxyethanesulfonic acid, 2-methacryloyloxyethanesulfonic acid, 3-acryloyloxy- and 3-methacryloyloxypropanesulfonic acid, vinylbenzenesulfonic acid and the salts thereof, ethylenically unsaturated phosphonic acids, such as vinylphosphonic acid and dimethyl vinylphosphonate and salts thereof, and α,β-ethylenically unsaturated C₃-C₈-mono- and C₄-C₈-dicarboxylic acids, in particular acrylic acid, methacrylic acid, crotonic acid, maleic acid, fumaric acid and itaconic acid. The proportion of monomers having acid groups will frequently account for not more than 20% by weight, preferably not more than 15% by weight, e.g. from 0.1 to 15% by weight and in particular from 0.5 to 10% by weight, based on the total amount of the monomers.

The monomers of group (ii) furthermore include monoethylenically unsaturated, neutral monomers, such as the amides of the abovementioned ethylenically unsaturated carboxylic acids, in particular acrylamide and methacrylamide, hydroxyalkyl esters of the abovementioned α,β-ethylenically unsaturated C₃-C₈-monocarboxylic acids and of the C₄-C₈-dicarboxylic acids, in particular 2-hydroxyethyl acrylate, 2-hydroxyethyl methacrylate, 2- and 3-hydroxypropyl acrylate, 2- and 3-hydroxypropyl methacrylate, esters of the abovementioned monoethylenically unsaturated mono- and dicarboxylic acids with C₂-C₄-polyalkylene glycols, in particular the esters of these carboxylic acids with polyethylene glycol or alkylpolyethylene glycols, the (alkyl)polyethylene glycol radical usually having a molecular weight in the range of from 100 to 3000. The monomers (ii) furthermore include N-vinylamides, such as N-vinylformamide, N-vinylpyrrolidone, N-vinylimidazole and N-vinylcaprolactam. The proportion of these monomers is likewise chosen so that the resulting polymers are insoluble in water. It is preferably not more than 20% by weight, and in particular not more than 10% by weight, e.g. from 0.1 to 10 and in particular from 0.5 to 5% by weight, based on the total amount of the monomers.

The monomers of group (ii) furthermore include monoethylenically unsaturated monomers which have at least one cationic group and/or at least one amino group protonatable in an aqueous medium, a quaternary ammonium group, a protonatable imino group or a quaternized imino group. Examples of monomers having a protonatable imino group are N-vinylimidazole and N-vinylpyridines. Examples of monomers having a quaternized imino group are N-alkylvinylpyridinium salts and N-alkyl-N′-vinylimidazolinium salts, such as N-methyl-N′-vinylimidazolinium chloride or methosulfate. Particularly preferred among these monomers are the monomers of the general formula I

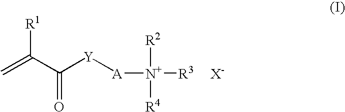

where
R¹ is hydrogen or C₁-C₄-alkyl, in particular hydrogen or methyl,
R² and R³, independently of one another, are C₁-C₄-alkyl, in particular methyl, and
R⁴ is hydrogen or C₁-C₄-alkyl, in particular hydrogen or methyl,
Y is oxygen, NH or NR⁵ where R⁵═C₁-C₄-alkyl,
A is C₂-C₈-alkylene, e.g. 1,2-ethanediyl, 1,2- or 1,3-propanediyl, 1,4-butanediyl or 2-methyl-1,2-propanediyl, which, if appropriate, is interrupted by 1, 2 or 3 non-neighboring oxygen atoms, and
X⁻ is an anion equivalent, e.g. is Cl⁻, HSO₄⁻, ½ SO₄²⁻ or CH₃OSO₃⁻ etc.,
and for Y═H, the free bases of the monomers of the formula I.

Examples of such monomers are 2-(N,N-dimethylamino)ethyl acrylate,
2-(N,N-dimethylamino)ethyl methacrylate, 2-(N,N-dimethylamino)ethylacrylamide,
3-(N,N-dimethylamino)propylacrylamide, 3-(N,N-dimethylamino)propylmethacrylamide,
2-(N,N-dimethylamino)ethylmethacrylamide,
2-(N,N,N-trimethylammonium)ethyl acrylate chloride,
2-(N,N,N-trimethylammonium)ethyl methacrylate chloride,
2-(N,N,N-trimethylammonium)ethylmethacrylamide chloride,
3-(N,N,N-trimethylammonium)propylacrylamide chloride,
3-(N,N,N-trimethylammonium)propylmethacrylamide chloride,
2-(N,N,N-trimethylammonium)ethylacrylamide chloride, and the corresponding methosulfates and sulfates.

The proportion of the cationic monomers in the emulsion polymer is advantageously from 0.1 to 20% by weight, in particular from 0.5 to 10% by weight and particularly preferably from 1 to 7% by weight, based on the total amount of the monomers.

The polymers can, if appropriate, comprise a further group of monomers (iii) incorporated in the form of polymerized units, which can usually be used as crosslinking agents in an emulsion polymerization. However, the proportion of monomers (iii) which have two or more ethylenically unsaturated double bonds usually accounts for not more than 10% by weight, in general not more than 5% by weight, in particular not more than 2% by weight, e.g. from 0.01 to 2% by weight and in particular from 0.05 to 1.5% by weight, based on the total amount of the monomers. Examples of crosslinking agents are butanediol diacrylate, butanediol dimethacrylate, hexanediol diacrylate, hexanediol dimethacrylate, glycol diacarylate, glycol dimethacrylate, trimethylolpropane triacrylate, trimethylolpropane trimethacrylate, pentaerythrityl triacrylate, pentaerythrityl tetraacrylate, diacrylates and dimethacrylates of alkoxylated dihydric alcohols, divinylurea and/or conjugated diolefins, such as butadiene or isoprene.

Depending on the intended use, monomers of group (iii) may also comprise so-called functional monomers, i.e. monomers which, in addition to a polymerizable C═C double bond, also have a reactive functional group, for example an oxirane group, a reactive carbonyl group, e.g. an acetoacetyl group, an isocyanate group, an N-hydroxymethyl group, an N-alkoxymethyl group, a trialkylsilyl group, a trialkoxysilyl group or another group reactive toward nucleophiles.

Those emulsion polymers whose monomer composition is chosen so that the resulting polymer has a glass transition temperature of at least 0° C., preferably at least 10° C., and in particular those in the range of from 20 to 130° C., are also of interest.

In order to prepare polymers having such a glass transition temperature, for example, the monomers (i) in the monomer mixture are chosen so that they correspond to polymer 1 having a theoretical glass transition temperature according to Fox T_{g} (Fox) of at least 50° C. According to Fox (T. G. Fox, Bull. Am. Phys. Soc. (Ser. II) 1, 123 [1956] and Ullmanns Enzyklopadie der technischen Chemie, Weinheim (1980), pages 17-18), the following is a good approximation for the glass transition temperature of uncrosslinked or weakly crosslinked copolymers in the case of large molar masses

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

where X¹, X², . . . , Xⁿ are the mass fractions of the monomers 1, 2, . . . , n and T_{g}¹, T_{g}², . . . , T_{g}ⁿ are the glass transition temperatures, in degrees Kelvin, of the polymers composed in each case only of one of the monomers 1, 2, . . . , n. The latter are known, for example, from Ullmann's Encyclopedia of Industrial Chemistry, VCH, Weinheim, vol. A 21 (1992) page 169, or from J. Brandrup and E.H. Immergut, Polymer Handbook 3rd ed., J. Wiley, New York 1989.

The polymerization of the monomers is effected by an emulsion polymerization method, i.e. the monomers to be polymerized are present as an aqueous emulsion in the polymerization mixture. The compounds used for stabilizing the monomer emulsions are the same as those which are used as a dispersion stabilizer for the preparation of the aqueous dispersions of reactive sizes, e.g. surfactants, in particular anionic surfactants, water-soluble starch, preferably anionic starch, and protective colloids.

The monomers can be initially taken in the reactor before the beginning of the polymerization or added in one or more portions or continuously to the polymerizing reaction mixture under polymerization conditions. For example, the main amount of the monomers, in particular at least 80% and particularly preferably the total amount, can be initially taken in the polymerization vessel and the polymerization started directly thereafter by adding a polymerization initiator. A further process variant consists in first initially taking a part (e.g. from 5 to 25%) of the monomers or of the monomer emulsion in the polymerization reactor, starting the polymerization by adding an initiator and adding the remaining amount of monomers or monomer emulsion continuously or in portions to the reactor and completing the polymerization of the monomers. In this process variant, the polymerization initiator can, for example, be partly or completely initially taken in the reactor or metered into the reactor separately from the remaining monomers.

The initiators suitable for the emulsion polymerization are in principle all polymerization initiators which are suitable for an emulsion polymerization and are usually used and which initiate a free radical polymerization of ethylenically unsaturated monomers. These include, for example, azo compounds such as 2,2′-azobisisobutyronitrile, 2,2′-azobis(2-methylbutyronitrile), 2,2′-azobis[2-methyl-N-(2-hydroxyethyl)propionamide, 1,1′-azobis(1-cyclohexanecarbonitrile), 2,2′-azobis(2,4-dimethylvaleronitrile), 2,2′-azobis(N,N′-dimethyleneisobutyramidine) dihydrochloride, and 2,2′-azobis(2-amidinopropane) dihydrochloride, organic and inorganic peroxides, such as diacetyl peroxide, di-tert-butyl peroxide, diamyl peroxide, dioctanoyl peroxide, didecanoyl peroxide, dilauroyl peroxide, dibenzoyl peroxide, bis(o-toluoyl)peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumyl hydroperoxide, tert-butyl peroxy-2-ethylhexanoate and diisopropyl peroxydicarbamate, salts of peroxodisulfuric acid and redox initiator systems.

A redox initiator system, in particular a redox initiator system which comprises a salt of peroxodisulfuric acid, hydrogen peroxide or an organic peroxide, such as tert-butyl hydroperoxide, as an oxidizing agent, is preferably used for the polymerization. The redox initiator systems preferably comprise, as a reducing agent, a sulfur compound which is selected in particular from sodium hydrogen sulfite, sodium hydroxymethanesulfinate and the hydrogen sulfite adduct of acetone. Further suitable reducing agents are phosphorus-containing compounds, such as phosphorous acid, hypophosphites and phosphinates, and hydrazine or hydrazine hydrate and ascorbic acid. Furthermore, redox initiator systems may comprise small added amounts of redox metal salts, such as iron salts, vanadium salts, copper salts, chromium salts and manganese salts, such as, for example, the redox initiator system ascorbic acid/iron(II)sulfate/sodium peroxodisulfate. Particularly preferred redox initiator systems are acetone bisulfite adduct/organic hydroperoxide, such as tert-butyl hydroperoxide; sodium disulfite (Na₂S2O₅)/organic hydroperoxide, such as tert-butyl hydroperoxide; sodium hydroxymethanesulfinate/organic hydroperoxide, such as tert-butyl hydroperoxide; and ascorbic acid/hydrogen peroxide.

The initiator is usually used in an amount of from 0.02 to 2% by weight and in particular from 0.05 to 1.5% by weight, based on the amount of the monomers. The optimum amount of initiator does of course depend on the initiator system used and can be determined by the person skilled in the art in routine experiments. The initiator can be partly or completely initially taken in the reaction vessel. In general, a portion of the initiator is initially taken together with a part of the monomer emulsion and the remaining initiator is added continuously or batchwise together with the monomers but separately therefrom.

Pressure and temperature are of minor importance for carrying out the polymerization of the monomers. The temperature does of course depend on the initiator system used. The optimum polymerization temperature can be determined by the person skilled in the art with the aid of routine experiments. Usually, the polymerization temperature is in the range of from 0 to 110° C., frequently in the range of from 30 to 95° C. The polymerization is usually carried out at atmospheric pressure or ambient pressure. However, it can also be carried out at superatmospheric pressure, e.g. up to 10 bar, or at reduced pressure, e.g. from 20 to 900 mbar, but generally at >800 mbar. The duration of polymerization is preferably from 1 to 120 minutes, in particular from 2 to 90 minutes, particularly preferably from 3 to 60 minutes, longer or shorter durations of polymerization also being possible.

Polymerization is preferably effected under the so-called “starved conditions”, i.e. conditions which allow as little formation as possible or no formation of empty micelles and hence the formation of polymer particles free of active substance. For this purpose, either no further surface-active substance is added or further surface-active substance is added only in such a small amount that the water-insoluble monomer droplets are stabilized in the aqueous phase. Thus, it is ensured that no measurable proportions of stabilized droplets of monomers are present in the reaction mixture in which a polymerization can take place, and the surface-active substances present in the polymerization mixture serve substantially for wetting the surface and for transporting the monomers (i) through the continuous aqueous phase.

If a dispersion stabilizer is also added in the emulsion polymerization for stabilizing the resulting emulsion polymers, at least one further surface-active substance is preferably metered in an amount of, for example, up to 5% by weight, e.g. from 0.1 to 5% by weight, based on the monomers to be polymerized. Suitable further surface-active substances in addition to the nonionic surface-active substances are in particular anionic emulsifiers, e.g. alkylsulfates, alkanesulfonates, alkylarylsulfonates, alkyl ether sulfates, alkylaryl ether sulfates, anionic starch, sulfosuccinates, such as sulfosuccinic monoesters and sulfosuccinic diesters, and alkyl ether phosphates and furthermore cationic emulsifiers.

In a preferred embodiment of the invention, the emulsion polymerization of the monomers is carried out in the presence of, for example, up to 20% by weight, in general up to 10% by weight, based on the total dispersion, of a cationically or anionically modified starch.

Of course, further additives which are customary in emulsion polymerization, for example, glycols, polyethylene glycols, buffers/pH regulators, molecular weight regulators and chain transfer inhibitors, may be added to the reaction mixture which is to be polymerized.

In order to modify the properties of the polymers, the emulsion polymerization can, if appropriate, be carried out in the presence of at least one polymerization regulator. Examples of polymerization regulators are organic compounds which comprise sulfur in bound form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea, aldehydes, such as formaldehyde, acetaldehyde and propionaldehyde, organic acids, such as formic acid, sodium formate or ammonium formate, alcohols, such as, in particular, isopropanol, and phosphorus compounds, such as sodium hypophosphite. If a regulator is used in the polymerization, the amount used in each case is, for example, from 0.01 to 5, preferably from 0.1 to 1, % by weight, based on the monomers used in the polymerization. Polymerization regulators and crosslinking agents can be used together in the polymerization. Consequently, for example, the rheology of the resulting polymer dispersions can be controlled.

The polymerization is carried out as a rule at a pH of from 2 to 9, preferably in the weakly acidic range at a pH of from 3 to 5.5. The pH can be adjusted to the desired value before or during the polymerization with customary acids, such as hydrochloric acid, sulfuric acid or acetic acid, or with bases, such as sodium hydroxide solution, potassium hydroxide solution, ammonia, ammonium carbonate, etc. The dispersion is preferably adjusted to a pH of from 5 to 7 after the end of the polymerization with sodium hydroxide solution, potassium hydroxide solution or ammonia.

In order to remove the remaining monomers as substantially as possible from the polymer dispersion, a postpolymerization is expediently carried out after the end of the actual polymerization. For this purpose, for example, an initiator from the group consisting of hydrogen peroxide, peroxides, hydroperoxides and/or azo initiators is added to the polymer dispersion after the end of the main polymerization. The combination of the initiators with suitable reducing agents, such as, for example, ascorbic acid or sodium bisulfite, is also possible. Oil-soluble initiators which are sparingly soluble in water, e.g. customary organic peroxides, such as dibenzoyl peroxide, di-tert-butyl peroxide, tert-butyl hydroperoxide, cumyl hydroperoxide or biscyclohexyl peroxydicarbonate, are preferably used. For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. For the postpolymerization, tert-butyl hydroperoxide is preferably used. The polymerization is carried out, for example, in a temperature range of from 40 to 100° C., in general from 50 to 95° C.

The starch-containing polymer dispersions comprise dispersed particles having a mean particle size of, for example, from 20 to 500 nm, preferably from 50 to 250 nm. The mean particle size can be determined by methods known to the person skilled in the art, such as, for example, laser correlation spectroscopy, ultracentrifuging or CHDF (Capillary Hydrodynamic Fractionation). A further measure of the particle size of the dispersed polymer particles is the LT value (value for the light transmittance). For determining the LT value, the polymer dispersion to be investigated in each case is measured in 0.1% strength by weight aqueous dilution in a cell having an edge length of 2.5 cm using light of 600 nm wavelength and compared with the corresponding transmittance of water under the same measuring conditions. The transmittance of water is stated as 100%. The more finely divided the dispersion, the higher is the LT value which is measured by the method described above. The mean particle size can be calculated from the measured values, cf. B. Verner, M. Barta, B. Sedlacek, Tables of Scattering Functions for Spherical Particles, Prague, 1976, Edice Marco, Rada D-DATA, SVAZEK D-1.

The solids content of the starch-containing polymer dispersion is, for example, from 5 to 50% by weight and is preferably in the range of from 15 to 40% by weight.

The finely divided, starch-containing polymer dispersions according to the invention comprise, for example, an emulsion polymer of
(i) at least one alkyl acrylate, alkyl methacrylate, vinyl ester of saturated carboxylic acids having 1 to 20 carbon atoms, vinylaromatics having up to 20 carbon atoms, ethylenically unsaturated nitrile, vinyl halide, vinyl ether of alcohols comprising 1 to 10 carbon atoms, aliphatic hydrocarbon having 2 to 40 carbon atoms and one or two double bonds or mixtures thereof and
(ii) if appropriate, at least one cationic and/or at least one anionic monomer.

In a preferred embodiment, the emulsion polymer comprises polymerized units of
(i) an alkyl acrylate, alkyl methacrylate, styrene, acrylonitrile, methacrylonitrile and mixtures thereof and
(ii) a dialkylaminoalkyl acrylate, dialkylaminoalkyl methacrylate, diallyldimethylammonium chloride, dialkylaminoalkylacrylamide, dialkylaminoalkylmethacrylamide, acrylic acid, methacrylic acid, itaconic acid, maleic acid, fumaric acid, crotonic acid and mixtures thereof.

The basic compounds can be used in the form of the free bases, in a form neutralized with acids or in quaternized form, while the acids can also be polymerized as salts or in a form partly neutralized with bases, such as sodium hydroxide solution, potassium hydroxide solution or ammonia.

Of particular industrial interest are emulsion polymers which are obtainable by free radical emulsion polymerization of
(i) acrylonitrile, methacrylonitrile, styrene and/or C₄- to C₂₄-olefins,
(ii) ethyl acrylate, n-butyl acrylate, tert-butyl acrylate, hexyl acrylate and/or ethylhexyl acrylate and, if appropriate,
(iii) further monomers
   in an aqueous solution of an enzymatically degraded starch, the enzymatic starch degradation being stopped by adding an acid having at least one phosphorus atom. The polymer dispersions may comprise, for example, up to 20% by weight of at least one enzymatically degraded starch. In general, the content of enzymatically degraded starch in the emulsion polymers is from 5 to 15% by weight.

A special example of starch-containing polymer dispersions comprises finely divided polymer dispersions which are obtainable by free radical emulsion copolymerization of ethylenically unsaturated monomers in the presence of at least one redox initiator and starch, if
(i) from 25 to 50% by weight of at least one optionally substituted styrene, methyl methacrylate, acrylonitrile and/or methacrylonitrile,
(ii) from 1 to 49% by weight of at least one C₁-C₄-alkyl acrylate and/or one C₂-C₄-alkyl methacrylate,
(iii) from 1 to 49% by weight of at least one C₅-C₂₂-alkyl acrylate and/or one C₅-C₂₂-alkyl methacrylate and
(iv) from 0 to 10% by weight of at least one other ethylenically unsaturated copolymerizable monomer,
   are used as ethylenically unsaturated monomers and
(v) from 15 to 40% by weight of at least one enzymatically degraded starch which has a molar mass M_{w} of from 1000 to 65 000
   are used as starch, the enzymatic starch degradation being stopped by adding an acid having at least one phosphorus atom, and the sum (i)+(ii)+(iii)+(iv)+(v) being 100% and being based on the total solids content, and the polymerization is carried out in the presence of at least 0.01% by weight, based on the monomers used, of at least one polymerization regulator.

Other polymer dispersions of interest are those which are obtainable by free radical emulsion copolymerization of ethylenically unsaturated monomers in the presence of at least one redox initiator and enzymatically degraded starch, if
(i) from 45 to 55% by weight of at least one optionally substituted styrene, methyl methacrylate, acrylonitrile and/or methacrylonitrile
(ii) from 15 to 29% by weight of at least one C₁-C₁₂-alkyl acrylate and/or one C₂-C₁₂-alkyl methacrylate and
(iii) from 0 to 10% by weight of at least one other ethylenically unsaturated copolymerizable monomer are used as ethylenically unsaturated monomers and
(iv) from 15 to 35% by weight of an enzymatically degraded cationized starch which has a molar mass M_{w} of from 1000 to 65 000 are used as starch, the enzymatic starch degradation being stopped by adding an acid having at least one phosphorus atom, and the sum (i)+(ii)+(iii)+(iv) being 100% and being based on the total solids content.

A further example comprises emulsion polymers which are obtainable by free radical polymerization of
(i) from 30 to 60% by weight of at least one optionally substituted styrene, acrylonitrile and/or methacrylonitrile,
(ii) from 5 to 50% by weight of at least one C₁-C₁₂-alkyl acrylate and/or one C₁-C₁₂-alkyl methacrylate,
(iii) from 5 to 30% by weight of at least one C₄-C₂₄-olefin,
(iv) from 0 to 10% by weight of at least one other ethylenically unsaturated copolymerizable monomer and
(v) from 15 to 35% by weight of an enzymatically degraded starch, the enzymatic starch degradation being stopped by addition of an acid having at least one phosphorus atom and the sum (i)+(ii)+(iii)+(iv)+(v) being 100% and being based on the total solids content. For the preparation of these polymer dispersions, olefins used are preferably isobutene, diisobutene, 1-octene, 1-decene, 1-dodecene and mixtures of such olefins.

The starch used in the enzymatic degradation may already have been subjected to an oxidative and/or hydrolytic degradation. It is also possible to subject an enzymatically degraded starch additionally to another starch degradation, such as an oxidative degradation. All that is important is that the enzymatic degradation be stopped by addition of an acid comprising a phosphorus atom and that the molar mass of the degraded starch be in the abovementioned range.

The finely divided, starch-containing polymer dispersions according to the invention have a lighter color than the starch-containing polymer dispersions known from the prior art. No complexing agents for heavy metal ions are required according to the invention in order to obtain such dispersions having a lighter color. However, a complexing agent for heavy metal ions may additionally be added to the starch-containing polymer dispersions according to the invention.

The finely divided, starch-containing polymer dispersions described above are used as sizes for paper and paper products, such as board and cardboard. They can be used both as surface size and as engine size in the amounts customary in each case. The use as surface size is preferred. The starch-containing polymer dispersions according to the invention can be processed by all methods suitable in the case of surface sizing. For use, the dispersion is usually added to the size press liquor in an amount of from 0.05 to 5% by weight, based on solid substance. The amount of polymer dispersion depends on the desired degree of sizing of the paper or paper products to be finished. The size press liquor may comprise further substances, such as, for example, starch, pigments, optical brighteners, biocides, strength agents for paper, fixing agents, antifoams, retention aids and/or drainage aids. The size dispersion can be applied to paper, board or cardboard by means of a size press or other application units, such as film press, speedsizer or gate-roll. The amount of polymer which is applied to the surface of paper products is, for example, from 0.005 to 1.0 g/m², preferably from 0.01 to 0.5 g/m².

The starch-containing polymer dispersion according to the invention can be used for the production of all paper varieties, for example of writing and printing papers and packaging papers, in particular of papers for packaging of liquids.

Paper products which are sized with the finely divided, starch-containing polymer dispersions according to the invention have an improved degree of sizing, good immediate sizing, improved inkjet printability, good toner adhesion and greater whiteness compared with papers which are sized with known sizes.

Unless otherwise evident from the context, the stated percentages in the examples are always percent by weight and the parts are parts by weight. The particle sizes were determined by means of a high performance particle sizer (HPPS) from Malvern using an He—Ne laser (633 nm) at a scattering angle of 173°.

The LT values of the aqueous polymer dispersions were determined in 0.1% strength aqueous dilutions using a DR/2010 apparatus from Hach at a wavelength of 600 nm.

### EXAMPLE 1

128.3 g of cationic cornstarch (D.S. value of 0.045) were initially taken in a 2 l flask having a plane-ground joint and a stirrer and internal temperature measurement. 485.9 g of water and 14 g of an α-amylase (1%, Termamyl® 120L from Novozymes) and 1.4 g of 25% strength calcium acetate hydrate were added with stirring. The mixture was heated to 85° C. and stirred at this temperature for 30 minutes. Thereafter, 1.01 g of phosphoric acid and 1.4 g of 10% strength iron(II) sulfate heptahydrate were added. 6.24 g of an 18% strength hydrogen peroxide solution were metered into the initially taken mixture in the course of 30 minutes. Thereafter, a monomer feed consisting of 49.3 g of water, 122.5 g of styrene, 61.25 g of n-butyl acrylate and 61.25 g of tert-butyl acrylate was started and was metered in over 120 min. At the same time, a feed of 56.2 g of 18% strength hydrogen peroxide solution was started over a period of 150 minutes. The mixture was postpolymerized for 30 minutes and then cooled to 50° C. For the postpolymerization, 17.6 g of a 10% strength tert-butyl hydroperoxide were added in the course of 60 minutes, the temperature was kept at 50° C. and the reaction mixture was then cooled to 30° C.

A finely divided polymer dispersion having a solids content of 35.7% and an LT value (0.1%) of 51% was obtained. The mean particle size of the dispersed particles was 106 nm.

### EXAMPLE 2

176.55 g of an anionic potato starch (D.S. value=0.044) were initially taken in a 3 l flask having a plane-ground joint and stirrer and internal temperature measurement. 810 g of demineralized water, 6 g of an α-amylase (1% strength, Termamyl® 120L from Novozymes) were added with stirring. The mixture was heated to 85° C. and stirred at this temperature for 30 min. Thereafter, 3.36 g of phosphoric acid (85% strength) and 6.5 g of 10% strength iron(II) sulfate heptahydrate were added and then 12 g of an 18% strength hydrogen peroxide solution were added. Thereafter, a monomer feed consisting of 300 g of demineralized water, 0.48 g of a mixture of the sodium salt of alkanesulfonates having an average chain length of C₁₋₅-alkyl (40% strength), 5.05 g of tert-dodecyl mercaptan, 204.04 g of styrene, 102.02 g of ethylhexyl acrylate and 102.02 g of tert-butyl acrylate was started. The feed duration was 90 min. At the same time, a feed of 107.4 g of 18% strength hydrogen peroxide solution was started over a period of 120 min. The mixture was postpolymerized for 30 minutes and then cooled to 50° C. Thereafter, 4.9 g of a 10% strength tert-butyl hydroperoxide were added, stirring was continued for a further 30 min and cooling to 30° C. was then effected. Thereafter, 20.94 g of 25% strength NaOH and 100 ml of water were added, with the result that the dispersion was made neutral.

A finely divided polymer dispersion having a solids content of 25.71% and an LT value (0.1%) of 87% was obtained. The mean particle size was 92 nm.

### EXAMPLE 3

176.55 g of an anionic potato starch (D.S. value=0.044) were initially taken in a 3 l flask having a plane-ground joint and stirrer and internal temperature measurement. 810 g of demineralized water, 6 g of an α-amylase (1% strength, Termamyl® 120L from Novozymes) were added with stirring. The mixture was heated to 85° C. and stirred at this temperature for 30 min. Thereafter, 3.36 g of phosphoric acid (85% strength) and 6.5 g of 10% strength iron(II) sulfate heptahydrate were added and then 12 g of an 18% strength hydrogen peroxide solution were added. Thereafter, a monomer feed consisting of 300 g of demineralized water, 0.48 g of a mixture of the sodium salt of alkanesulfonates having an average chain length of C₁₋₅-alkyl (40% strength), 204.04 g of styrene, 102.02 g of n-butyl acrylate and 102.02 g of tert-butyl acrylate was started. The feed duration was 90 min. At the same time, a feed of 107.4 g of 18% strength hydrogen peroxide solution was started over a period of 120 min. The mixture was postpolymerized for 30 minutes and then cooled to 50° C. Thereafter, 4.9 g of a 10% strength tert-butyl hydroperoxide were added, stirring was continued for a further 30 min and cooling to 30° C. was then effected. Thereafter, 20.94 g of 25% strength NaOH and 100 ml of water were added, with the result that the dispersion was made neutral. A finely divided polymer dispersion having a solids content of 24.91% and an LT value (0.1%) of 82% was obtained. The mean particle size was 101 nm.

### EXAMPLE 4

128.3 g of cationic cornstarch (D.S. value of 0.045) were initially taken in a 2 l flask having a plane-ground joint and a stirrer and internal temperature measurement. 485.9 g of water, 14 g of an α-amylase (1%, Termamyl® 120L from Novozymes) and 1.4 g of 25% strength calcium acetate hydrate were added with stirring. The mixture was heated to 85° C. and stirred at this temperature for 30 minutes. Thereafter, 1.01 g of phosphoric acid and 1.4 g of 10% strength iron(II) sulfate heptahydrate were added. 6.24 g of an 18% strength hydrogen peroxide solution were metered into the initially taken mixture in the course of 30 minutes. Thereafter, a monomer feed consisting of 49.3 g of water, 332.8 g of acrylonitrile and 270.6 g of n-butyl acrylate was started and was metered in over 120 min. At the same time, a feed of 56.2 g of 18% strength hydrogen peroxide solution was started over a period of 150 minutes. The mixture was postpolymerized for 30 minutes and then cooled to 50° C. For the postpolymerization, 17.6 g of a 10% strength tert-butyl hydroperoxide were added in the course of 60 minutes, the temperature was kept at 50° C. and the reaction mixture was then cooled to 30° C.

A finely divided polymer dispersion having a solids content of 35% and an LT value (0.1%) of 51% was obtained. The mean particle size of the dispersed particles was 103 nm.

### EXAMPLE 5

176.55 g of an anionic potato starch (D.S. value=0.044) were initially taken in a 3 l flask having a plane-ground joint and a stirrer and internal temperature measurement. 810 g of demineralized water and 6 g of an α-amylase (1% strength, Termamyl® 120L from Novozymes) were added with stirring. The mixture was heated to 85° C. and stirred at this temperature for 30 min. Thereafter, 3.36 g of phosphoric acid (85% strength) and 6.5 g of 10% strength iron(II) sulfate heptahydrate were added and 12 g of an 18% strength hydrogen peroxide solution were then added. Thereafter, a monomer feed consisting of 300 g of demineralized water, 0.48 g of a mixture of the sodium salt of alkanesulfonates having an average chain length of C₁₋₅-alkyl (40% strength), 576.4 g of acrylonitrile and 274.6 g of n-butyl acrylate was started. The feed duration was 90 min. At the same time, a feed of 107.4 g of 18% strength hydrogen peroxide solution was started over a period of 120 min. The mixture was postpolymerized for 30 min and then cooled to 50° C. Thereafter, 4.9 g of a 10% strength tert-butyl hydroperoxide were added, stirring was continued for a further 30 min and cooling to 30° C. was then effected. Thereafter, 20.94 g of 25% strength NaOH and 100 ml of water were added, with the result that the dispersion was made neutral. A finely divided polymer dispersion having a solids content of 30% and an LT value (0.1%) of 82% was obtained. The mean particle size was 98 nm.

### COMPARATIVE EXAMPLE 1

### Example 2 from EP-A 307 816)

31.1 g of an oxidatively degraded potato starch (Amylofax® 15 from Avebe) in 199.5 g of demineralized water were initially taken under a nitrogen atmosphere and with stirring in a polymerization vessel which was equipped with a stirrer, reflux condenser, jacket heating and metering apparatus. The starch was dissolved with stirring by heating to 85° C. At this temperature, 5.6 g of glacial acetic acid, 0.05 g of iron(II) sulfate (FeSO₄.7H₂O) and 1.2 g of a 30% strength by weight hydrogen peroxide solution were added in succession. After 20 minutes, a further 1.2 g of the 30% strength by weight hydrogen peroxide solution were added. Thereafter, a mixture consisting of 66 g of n-butyl acrylate, 58.5 g of styrene, 0.07 g of sodium laurylsulfate and 43.5 g of demineralized water was metered in the course of 2 h. The initiator feed of 21 g of a 5.5% strength by weight hydrogen peroxide solution began simultaneously and was likewise metered over 2 h at a constant metering rate. After the end of the feeds postpolymerization was effected for a further hour at 85° C. After filtration (125 μm), a dispersion having a solids content of 33.9%, an LT value (0.01%) of 86 and a particle size of 110 nm was obtained.

The finely divided, starch-containing polymer dispersions described above were tested as surface sizes for paper.

### Test Methods:

The degree of sizing was determined according to Cobb60 according to DIN EN 20 535. The HST value was determined by the Hercules Sizing Test according to Tappi standard T 530. The whiteness of paper was determined as CIE whiteness according to ISO 11475.

### Testing of Performance Characteristics as Surface Size

An anionically modified potato starch was brought into solution by heating to 95° C. for 30 minutes. Thereafter, the polymer dispersion to be tested was added to the starch solution and dilution was effected with an amount of water such that a starch concentration of 8% was present in the prepared mixture. The mixture of starch solution and polymer dispersion was then applied at a temperature of 55° C. by means of a size press to a paper having a grammage of 80 g/m² which had not been pre-sized in the pulp. The amounts of polymer dispersion applied to the paper were 1 g/l, 2 g/l and 3 g/l (based on solids of the polymer dispersion). The uptake of preparation was in the range of 50-56%. Thereafter, the papers thus treated were dried by means of contact drying at 90° C., conditioned for 24 h at 50% relative humidity and then subjected to the tests. The results of the tests obtained in each case are shown in the table.

| | | | | CIE |
|---|---|---|---|---|
| | Cobb60 | Cobb60 | Cobb60 | whiteness |
| Example No. | (at 1 g/l) | (at 2 g/l) | (at 3 g/l) | (at 3 g/l) |
| Example 1 | 65 | 39 | 26 | 126 |
| Example 2 | 72 | 45 | 31 | 131 |
| Example 3 | 62 | 37 | 25 | 128 |
| Example 4 | 58 | 35 | 23 | 125 |
| Example 5 | 63 | 41 | 26 | 131 |
| Comparative | 75 | 51 | 35 | 112 |
| Example | | | | |

1. A finely divided starch-containing polymer dispersion which is obtained by free radical emulsion copolymerization of ethylenically unsaturated monomers in the presence of a redox initiator and an enzymatically degraded starch, wherein the enzymatically degraded starch is an aqueous reaction mixture which is obtained by stopping the enzymatic starch degradation with at least one acid comprising a phosphorus atom.

2. The finely divided, starch-containing polymer dispersion according to claim 1, wherein the enzymatically degraded starch is an aqueous reaction mixture which is obtained by stopping the enzymatic starch degradation with an acid from the group consisting of phosphoric acid, phosphonic acid, phosphinic acid, peroxophosphoric acid, hypodiphosphonic acid, diphosphonic acid, hypodiphosphoric acid, diphosphoric acid, peroxodiphosphoric acid, polyphosphoric acid, metaphosphoric acid and mixtures thereof.

3. The finely divided, starch-containing polymer dispersion according to claim 1, wherein the enzymatically degraded starch is an aqueous reaction mixture which is obtained by stopping the enzymatic starch degradation with an acid from the group consisting of nitrilotris(methylenetriphosphonic acid), ethylenediaminetetrakis(methylenetetraphosphonic acid), diethylenetriaminepentakis(methylenephosphonic acid), 2-phosphonobutane-1,2,4-tricarboxylic acid, 1-hydroxyethane-1,1-diphosphonic acid, 1-aminoethane-1,1-diphosphonic acid, phosphonoformic acid, phosphonoacetic acid, phenylphosphonic acid and at least one alkylphosphonic acid.

4. The finely divided starch-containing polymer dispersion according to claim 1, wherein the enzymatically degraded starch is an aqueous reaction mixture which is obtainable obtained by stopping the enzymatic starch degradation with a polymer which comprises at least one vinylphosphonyl unit incorporated in the form of polymerized units.

5. The finely divided, starch-containing polymer dispersion according to claim 1, wherein the enzymatically degraded starch is an aqueous reaction mixture which is obtained by stopping the enzymatic starch degradation with polyvinylphosphonic acid.

6. The finely divided, starch-containing polymer dispersion according to claim 1, which is obtained by free radical emulsion polymerization of
(i) at least one monomer from the group consisting of alkyl acrylate, alkyl methacrylate, vinyl ester of saturated carboxylic acids having 1 to 20 carbon atoms, vinylaromatics having up to 20 carbon atoms, ethylenically unsaturated nitrile, vinyl halide, vinyl ether of alcohols comprising 1 to 10 carbon atoms, aliphatic hydrocarbon having 2 to 40 carbon atoms and one or two double bonds and mixtures thereof and
(ii) optionally, at least one cationic and/or at least one anionic monomer.

7. The finely divided, starch-containing polymer dispersion according to claim 1, which is obtained by free radical emulsion polymerization of
(i) an alkyl acrylate, alkyl methacrylate, styrene, acrylonitrile, methacrylonitrile and mixtures thereof and
(ii) a dialkylaminoalkyl acrylate, dialkylaminoalkyl methacrylate, diallyldimethylammonium chloride, dialkylaminoalkylacrylamide, dialkylaminoalkylmethacrylamide, acrylic acid, methacrylic acid, itaconic acid, maleic acid, fumaric acid, crotonic acid and mixtures thereof.

8. The finely divided, starch-containing polymer dispersion according to claim 1, which is obtainable obtained by free radical emulsion polymerization of
(i) acrylonitrile, methacrylonitrile, styrene and/or C₄- to C₂₄-olefins,
(ii) ethyl acrylate, n-butyl acrylate, tert-butyl acrylate, hexyl acrylate and/or ethylhexyl acrylate and, optionally,
(iii) additional monomers.

9. A composition for stopping the enzymatic degradation of starch comprising an acid comprising at least one phosphorus atom.

10. A size for paper and paper products comprising the finely divided, starch-containing polymer dispersion according to claim 1.

11. A surface size for paper, board and cardboard comprising the size according to claim 10.
